(19) United States
(12) Patent Application Publication
(10) Pub. No.: US 2012/0288310 A1
(43) Pub. Date: Nov. 15, 2012

(54) SHEET STORAGE APPARATUS AND IMAGE FORMING APPARATUS

(75) Inventors: Daisaku Kamiya, Abiko-shi (JP); Hideki Kushida, Moriya-shi (JP); Naoto Tokuma, Abiko-shi (JP); Toshiyuki Iwata, Abiko-shi (JP); Toshiki Momoka, Tokyo (JP)

(73) Assignee: CANON KABUSHIKI KAISHA, Tokyo (JP)

(21) Appl. No.: 13/456,618

(22) Filed: Apr. 26, 2012

(30) Foreign Application Priority Data
May 11, 2011 (JP) 2011-105843

(51) Int. Cl. G03G 15/00; B65H 29/20; B65H 31/24

(52) U.S. Cl. 399/381; 271/207; 271/314; 271/299

(57) ABSTRACT

This invention regards to a sheet storage apparatus. A forward and reversely rotatable conveying roller 301 which conveys a sheet to a tray 330 is disposed at a sheet conveying path R which guides the sheet conveyed from an image forming apparatus main body to the tray of the sheet storage apparatus 300. A retraction path 503 where the sheet is conveyed by reversely rotating the conveying roller is branched from the sheet conveying path upstream of the conveying roller. When plural sheets are stored in the tray, the sheets are conveyed to the retraction path by reversely rotating the conveying roller until a final sheet has been conveyed from the image forming apparatus main body, and when the final sheet has been conveyed, the sheets conveyed to the retraction path and the final sheet are conveyed in a state of being overlaid on one another to the tray.

### BACKGROUND OF THE INVENTION

1. Field of the Invention

The present invention relates to a sheet storage apparatus and an image forming apparatus, specifically, having a constitution in which a sheet storage apparatus is disposed on an upper face of a main body of an image forming apparatus.

2. Description of the Related Art

In recent years, it is common that a single image forming apparatus, such as a printer or a copying machine, is used by plural users according to networking of offices. When a single image forming apparatus is commonly used by plural users, output sheets of plural users should be prevented from being mixedly rested on the same tray. Therefore, in some conventional image forming apparatuses, there is provided a sheet storage apparatus configured to sort sheets discharged, after images have been formed thereon, from a main body of an image forming apparatus according to users and store the sorted sheets.

As an example of such sheet storage apparatus, there is a bin-moving type sorter in which plural bins are disposed so as to be movable vertically for storing sheets which are discharged after images have been formed thereon (refer to U.S. Pat. No. 5,722,030). Moreover, there is a fixed-type sorter for sorting sheets into fixed plural bins (refer to Japanese Patent Laid-Open No. 05-294544).

However, the sorters of such conventional sheet storage apparatuses are configured to sequentially store sheets in flat states on the bin trays which are disposed in substantially horizontal positions, or slightly slant positions. Moreover, the plural bin trays of these constitutions are arranged vertically such that the bin trays are changed according to jobs of discharged sheets in order to facilitate the discrimination of discharged sheets. Accordingly, the vertical positions of the bin trays are different from each other so that the sheets stored in the lower bin trays cannot be easily confirmed by sight and easily taken out.

Moreover, a sheet bundle discharged on a bin tray is not restrained in the sheet bundle state, except in such cases that, for example, the sheet bundle is stapled. Accordingly, the sheets may be disordered on the bin tray when a sheet bundle is taken out of a bin tray, and other sheet bundles are erroneously abutted by the same, or when the conditions of the sheets when they are discharged are not good (curl, surface friction, etc.). Such cases may result in lowering easiness of taking out sheets, or causing machine troubles, such as a discharging error of an apparatus.

The present invention has been made while taking into account such current situations in order to provide a sheet storage apparatus and an image forming apparatus which are able to improve easiness of taking out sheets and a visual confirmation, and stably store sheets.

### SUMMARY OF THE INVENTION

The present invention is a sheet storage apparatus provided with a sheet storage portion, having a sheet holding portion which allows a sheet to pass through in a sheet conveying direction and is able to restrict a movement of the sheet in a direction opposite to the sheet conveying direction, which receives the sheet conveyed from below and holds the sheet in a vertical state by the sheet holding portion so as to store the sheet, and a sheet conveying portion, having an overlaying portion which overlays sheets to be stored in the sheet storage portion on one another, which conveys plural sheets in a state of being overlaid on one another by the overlaying portion to the sheet storage portion.

According to the present invention, when plural sheets are to be stored, the plural sheets are overlaid by the overlaying portion to be conveyed, thereby improving easiness of taking out sheets and visual confirmation, and enabling a stable storage of sheets.

Further features of the present invention will become apparent from the following description of exemplary embodiments with reference to the attached drawings.

### BRIEF DESCRIPTION OF THE DRAWINGS

FIG. 1 is a drawing illustrating a constitution of an image forming apparatus provided with a sheet storage apparatus according to an embodiment of the present invention;

FIG. 2 is a drawing illustrating a constitution of the above-mentioned sheet storage apparatus;

FIG. 3A is a drawing illustrating a constitution of a storing and holding portion of a tray disposed on the above-mentioned sheet storage apparatus; FIG. 3B is a drawing illustrating a constitution of the storing and holding portion of the tray disposed on the above-mentioned sheet storage apparatus; FIG. 3C is a drawing illustrating a constitution of the storing and holding portion of the tray disposed on the above-mentioned sheet storage apparatus;

FIG. 4 is a control block diagram for controlling the main body of the image forming apparatus and the above-mentioned sheet storage apparatus;

FIG. 5 is a control block diagram of a sheet storage apparatus controller for controlling the above-mentioned sheet storage apparatus;

FIG. 6 is a flow chart illustrating a sheet storing operation control of the above-mentioned sheet storage apparatus;

FIG. 7A is a first drawing illustrating an operation for storing and holding sheets in the storing and holding portion of the above-mentioned tray; FIG. 7B is a first drawing illustrating an operation for storing and holding sheets in the storing and holding portion of the above-mentioned tray;

FIG. 8A is a second drawing illustrating an operation for storing and holding sheets in the storing and holding portion of the above-mentioned tray; FIG. 8B is a second drawing illustrating an operation for storing and holding sheets in the storing and holding portion of the above-mentioned tray;

FIG. 9A is a third drawing illustrating an operation for storing and holding sheets in the storing and holding portion of the above-mentioned tray; FIG. 9B is a third drawing illustrating an operation for storing and holding sheets in the storing and holding portion of the above-mentioned tray;

FIG. 10 is a perspective view illustrating a state of a sheet which is held in the storing and holding portion of the above-mentioned tray; and

FIG. 11 is a diagram illustrating the configuration of an another holding portion of a tray mounted in the sheet storage device.

### DESCRIPTION OF THE EMBODIMENTS

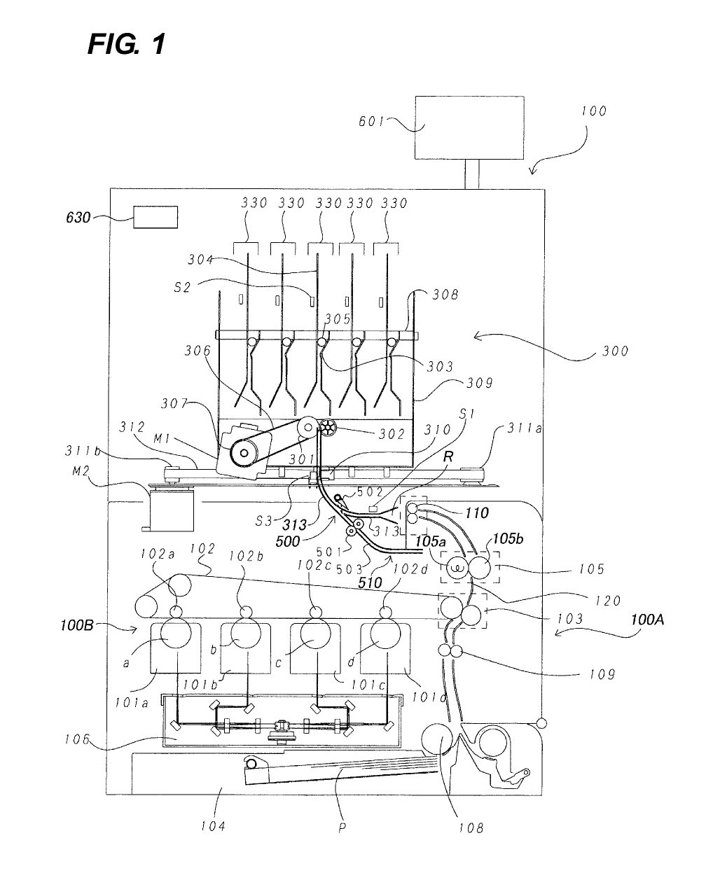

An embodiment of the present invention is described in detail hereunder. FIG. 1 is a drawing illustrating a constitution of an image forming apparatus provided with a sheet storage apparatus according to the embodiment of the present invention. The image forming apparatus 100 includes a main body 100A of the image forming apparatus (called “apparatus main body” hereunder), an image forming portion 100B for forming an image on a sheet, and the sheet storage apparatus 300 disposed on (above) the top face of the apparatus main body 100A.

Here, the image forming portion 100B includes photosensitive drums a to d for forming toner images of colors of yellow, magenta, cyan, and black, and an exposure device 106 for forming electrostatic latent images on the photosensitive drums a to d by irradiating laser beams based on image information, etc. Note that, the photosensitive drums a to d are driven by motors (not shown), and primary chargers, development devices, and transfer chargers (not shown), which are formed into units as process cartridges 101a to 101d, are disposed around the photosensitive drums a to d, respectively.

An intermediate transfer belt 102 driven to rotate in the direction of arrow is applied with transfer biases by transfer chargers 102a to 102d so that toner images of respective colors on the photosensitive drums a to d are sequentially transferred to the intermediate transfer belt 102 so as to be superposed. With this, a full color image is formed on the intermediate transfer belt.

A secondary transfer portion 103 transfers a full color image, which has been formed on the intermediate transfer belt 102, on a sheet P. This secondary transfer portion 103 is constituted by a secondary transfer counter roller 103b which supports the intermediate transfer belt 102, and a secondary transfer roller 103a which abuts the secondary transfer counter roller 103b via the intermediate transfer belt 102. There are provided a registration roller 109, a sheet cassette 104, and a pickup roller 108 for feeding the sheets P which are stored in the apparatus main body 100A. There is also provided a CPU circuit portion 630 which is a controller for executing control of the apparatus main body 100A and the sheet storage apparatus 300.

Next, an image forming operation of thus constituted image forming apparatus 100 is described. When an image forming operation has been started, first, the exposure device 106 irradiates laser beams based on image information from a personal computer, or the like (not shown) so as to sequentially irradiate the photosensitive drums a to d having surfaces which have been uniformly charged with predetermined polarity and voltage, so that electrostatic latent images are formed on the photosensitive drums a to d. Then, the electrostatic latent images are developed with toner to be visualized.

For example, first, the photosensitive drum a is irradiated with a laser beam corresponding to an image signal of a color component of yellow of a manuscript via a polygon mirror etc. of the exposure device 106, so that an electrostatic latent image of yellow is formed on the photosensitive drum a. Then, this electrostatic latent image of yellow is developed with yellow toner from the development device to be visualized as an yellow toner image. After that, this toner image reaches the primary transfer portion where the photosensitive drum a abuts the intermediate transfer belt 102 according to the rotation of the photosensitive drum a. Here, when the toner image has reached the primary transfer portion like this, by a primary transfer bias applied to the transfer charger 102a, the yellow toner image on the photosensitive drum a is transferred on the intermediate transfer belt 102 (primary transfer).

Next, when the portion of the intermediate transfer belt 102 carrying the yellow toner image moves, the magenta toner image, which has already been formed on the photosensitive drum b by a similar method mentioned above, is transferred on the intermediate transfer belt 102 over the yellow toner image. Similarly, as the intermediate transfer belt 102 is moving, a cyan toner image and a black toner image are superposed on the yellow toner image and the magenta toner image at the primary transfer portions, respectively. With this, a full color toner image is formed on the intermediate transfer belt 102.

Simultaneously with this image forming operation, the sheets P stored in the sheet cassette 104 are fed out by the pickup roller 108 sheet by sheet. Then, the sheet P reaches the registration roller 109, and, after adjusting the timing by the registration roller 109, the sheet P is conveyed to the secondary transfer portion 103. After that, in this secondary transfer portion 103, by a second transfer bias applied to the secondary transfer roller 103a which is a transfer portion, the toner images of four colors on the intermediate transfer belt 102 are integrally transferred (secondary transfer).

Next, the sheet P, on which the toner images have been transferred, is conveyed from the secondary transfer portion 103 to a fixing portion 105. Then, by a heating roller 105a and a pressing roller 105b disposed on this fixing portion 105, the toner of respective colors is applied with heat and pressure to melt so that the colors are mixed, thereby fixing a full color image on the sheet P. After that, the sheet P, on which the image has been fixed accordingly, is discharged by a pair of discharge rollers 110 disposed downstream of the fixing portion 105, and conveyed through a conveying guide 313 having a curved shape to a sheet storage apparatus 300 disposed on the upper face of the apparatus main body 100A.

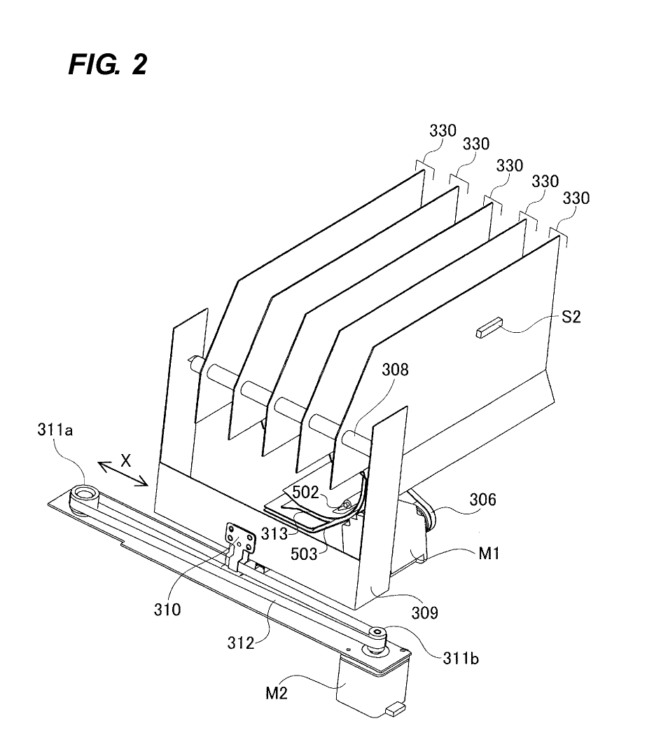

Here, the sheet storage apparatus 300 as a sheet holding portion allows the sheet to be conveyed to pass through in the sheet conveying direction, and includes a constitution capable of restricting movement of sheet in the direction opposite to the sheet conveying direction. Moreover, the sheet storage apparatus 300 receives the sheets which are sequentially conveyed from the apparatus main body 100A from below so as to store the sheets in their vertical states. As illustrated in FIG. 2, this sheet storage apparatus 300 is provided with plural trays 330 (the number is five in the present embodiment) as a sheet storage portion which are disposed side by side along the lateraldirection so as to store the sheets in their vertical states. Respective trays 330 are movable laterally so as to receive the conveyed sheet from below selectively and hold the sheets in the above-mentioned sheet holding portions in their vertical states and store the sheets. By arranging five trays 330 on the upper portion of the apparatus main body 100A side by side like this, the amount of storage can be increased without enlarging the footprint of the apparatus. Moreover, by storing sheets in their vertical states, even when sheets of large size are stored, the footprint of the apparatus does not need to be enlarged.

As illustrated in FIG. 1, this storage apparatus 300 is provided with a sheet conveying portion 500 which conveys a sheet discharged from the apparatus main body 100A selectively to one of the five trays 300. This sheet conveying portion 500 is provided with a conveying guide 313 which constitutes a sheet conveying path R for guiding the sheet P from the apparatus main body 100A to the tray 330 of the sheet storage apparatus 300.

This conveying guide 313 (sheet conveying path R) is provided at its downstream portion in the sheet conveying direction with a forward and reversely rotatable conveying roller 301 and a conveying rotatable driven member 302 which is pressed against the conveying roller 301. The sheet P is conveyed by the conveying roller 301 and the conveying rotatable driven member 302 selectively to one of the five trays 330. The conveying roller 301 and the conveying rotatable driven member 302 constitute a conveying portion for conveying plural sheets which have been overlaid on one another by the overlaying portion. The sheet storage apparatus 300 is provided with an entrance sensor S1 disposed at an entrance portion of the conveying guide 313 so that the conveying timing of the sheet P from the apparatus main body 100A is monitored by this entrance sensor S.

Rotational driving force is applied to the conveying roller 301 by a conveying roller drive gear 307 and a conveying roller drive belt 306 which are driven by a forward and reversely rotatable conveying motor M1. When conveying a sheet to the tray 330, the conveying roller 301 is rotated forward, and when sheets are conveyed in a state of being overlaid on one another to the tray 330 as described later, the conveying roller 301 is temporarily rotated reversely.

As illustrated in FIG. 2, the trays 330 are connected by a storage portion connecting shaft 308, and are held by a storage portion holding plate 309. Here, a storage portion moving connection member 310 is fixed to the storage portion holding plate 309. The storage portion moving connection member 310 is fixed to a timing belt 312 wound on a moving pulley 311b disposed coaxially with a storage portion moving motor M2 and a moving pulley 311a disposed at the opposite side.

With this, when the timing belt 312 is rotated, the storage portion holding plate 309 moves together with the storage portion moving connection member 310, and thereby moving the trays 330 integrally in the direction of arrows X (lateral direction, right and left directions). By moving the trays 330 in the right and left directions, the tray 330 which faces the conveying roller 301 can be changed so that the sheets P conveyed form the conveying roller 301 can be stored, while being sorted, to respective five trays 330.

The sheet storage apparatus 300 is provided with a storage portion movement detection sensor (not shown) for detecting a home position of the storage portion moving connection member 310. By using this storage portion movement detection sensor, a delivery position of the trays 330 is determined based on the home position at the center of the trays 330 in X-directions (lateral direction, right and left directions) illustrated in FIG. 2, and the number of driving pulses of the storage portion moving motor M2 from the home position.

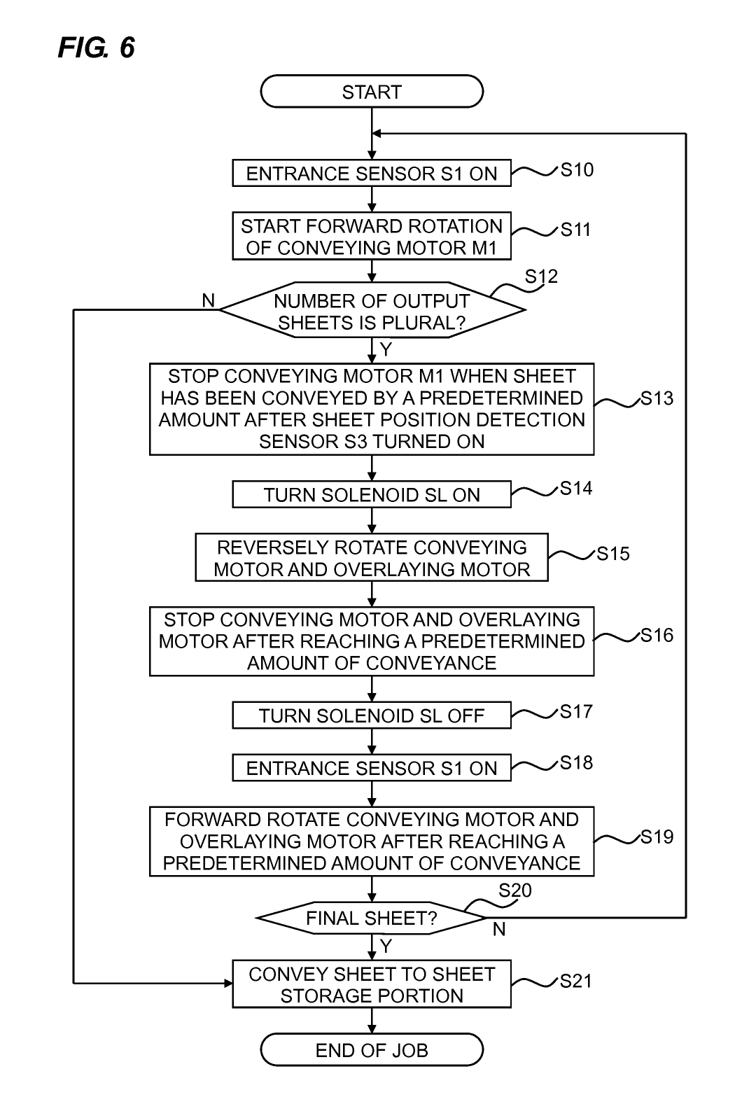

The trays 330 are provided with sheet detection sensors S2, respectively. These sheet detection sensors S2 detect whether sheets are stored in respective trays 330. A CPU 60 of a sheet storage apparatus controller 636 illustrated in FIG. 6 and described later controls the positions of trays 330 so as to deliver the next discharged sheet P into the tray storing no sheet.

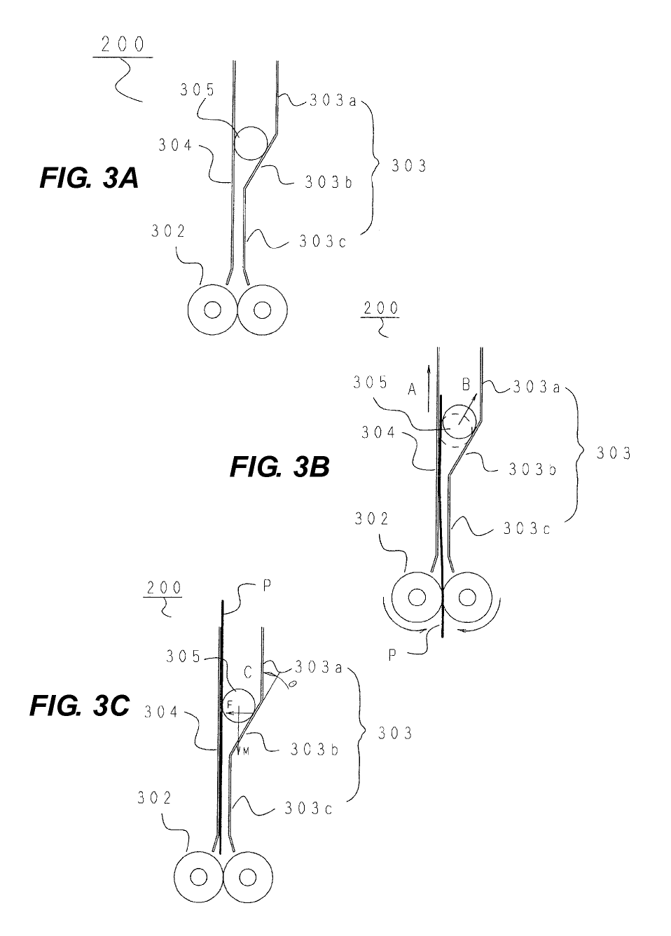

FIGS. 3A, 3B and 3C are drawings illustrating the constitutions of the storing and holding portion 200 which receives sheets for the tray 330 from below and stores the sheets in their vertical states so as to be held. The storing and holding portion 200 is provided with a substantially vertical storage guide 304, a conveying guide 303 disposed opposite to the storage guide 304, and a holding member 305 disposed between the storage guide 304 and the conveying guide 303. The holding member 305 has a columnar shape so as to nip and hold sheets in cooperation with the storage guide 304. Here, in the present embodiment, the holding member 305 has a columnar shape, but may alternatively has a spherical shape, cylindrical shape, or a spindle shape.

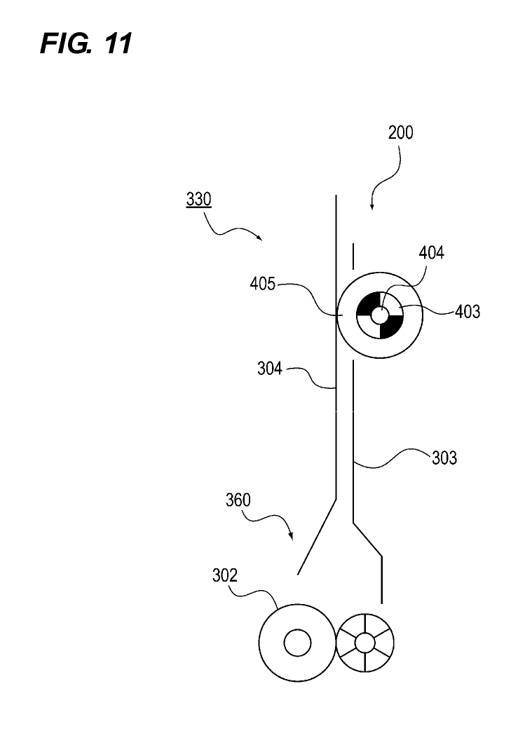

Further, as illustrated in FIG. 11, a fixed shaft 404 may be provided on the conveying guide 303, and a sponge roller 405 may be also provided on the fixed shaft 404 as the holding member with a one-way clutch 403 interposed therebetween. The sponge roller 405 is configured with an elastic foam, and is provided to abut on the storage guide 304 in an elastically deformed state. The one-way clutch 403 is freely rotatable in the clockwise direction in FIG. 11. However, the one-way clutch 403 follows the fixed shaft 404 in the counterclockwise direction and so is configured not to rotate in the counterclockwise direction. In other words, the sponge roller 405 in which the one-way clutch 403 is incorporated rotates to follow the sheet conveyed to the sheet storage portion 330 by the conveying roller 301 and the driven roller 302 which function as the sheet conveying portion. Meanwhile, sheet movement in a direction opposite to the sheet conveying direction is restricted by pressing force of the sponge roller 405 which is generated between the storage guide 304 and the sponge roller 405, and so the sheet is held against a weight thereof.

The storage guide 304 as a first guide member forms a side wall of the storing and holding portion 200 so as to guide upward a sheet conveyed from below. The conveying guide 303 as a second guide member is provided with an opposite wall portion 303a which is disposed at the upper portion, and a lower guide portion 303c which is disposed at the lower portion so as to guide upward a sheet together with the storage guide 304. The conveying guide 303 includes an inclined portion 303b which is inclined so that the horizontal distance between the storage guide 304 and the inclined portion 303b is gradually increasing in the upward direction. The inclined portion 303b is disposed above the lower guide portion 303c, i.e., between the opposite wall portion 303a and the lower guide portion 303c.

The holding member 305 is disposed so as to be movable between the storage guide 304 and the opposite wall portion 303a and the inclined portion 303b of the conveying guide 303. This holding member 305 maintains due to its self-weight a state of abutting the storage guide 304 and the inclined portion 303b of the conveying guide 303.

With this, the holding member 305 can freely move in the direction in which the distance between the guides is increasing, i.e., the upward direction, but cannot move in the direction in which the distance between the guides is decreasing, i.e., the downward direction. The conveying guide 303 or the storage guide 304 is provided with a latching portion (not shown) in a range of not disturbing the conveyance of the sheet P so that the holding member 305 cannot drop out by moving in the directions perpendicular to the sheet of the drawing which are perpendicular to the sheet conveying direction.

On the other hand, when the sheet P is conveyed by the conveying roller 301 to the storing and holding portion 200, as illustrated in FIG. 3B, the holding member 305 is pressed by the sheet P which is passing through the nip portion between the storage guide 304 and the holding member 305. With this, the holding member 305 moves by the thickness of the sheet P in the direction of arrow B along the sheet P while being pressed upward by the sheet P. In the present embodiment, the holding member 305 is formed by a lightweight material so as to be movable in the direction of arrow B by the conveyed sheet P when the sheet P is passing through the nip portion between the storage guide 304 and the holding member 305. With this, the holding member 305 can be moved upward by the weak force in the direction of arrow B so as to store the sheet P in the storing and holding portion 200.

When the trailing edge of the sheet P has passed through the conveying roller 301, as illustrated in FIG. 3C, an abutment force F (=M/tan θ) is applied to the sheet P in the direction toward the storage guide 304 due to the gravity M acting on the holding member 305 which is positioned at the inclined portion 303b. Namely, when the trailing edge of the sheet P has passed through the conveying roller 301, the holding member 305 generates a wedge effect on the sheet P. Then, the sheet P is held in the storing and holding portion 200 due to the abutment force F acting on the sheet P as this wedge effect.

Note that, in the present embodiment, when plural sheets P are to be stored in the tray 330, the plural sheets P are conveyed to the tray 330 in a state where the plural sheets P are overlaid on one another. In order to convey plural sheets to the tray 330 in an overlaid state, as illustrated in FIG. 1, the sheet conveying portion 500 is provided with a sheet overlaying portion 510 branched from the sheet conveying path R for overlaying the sheets on one another.

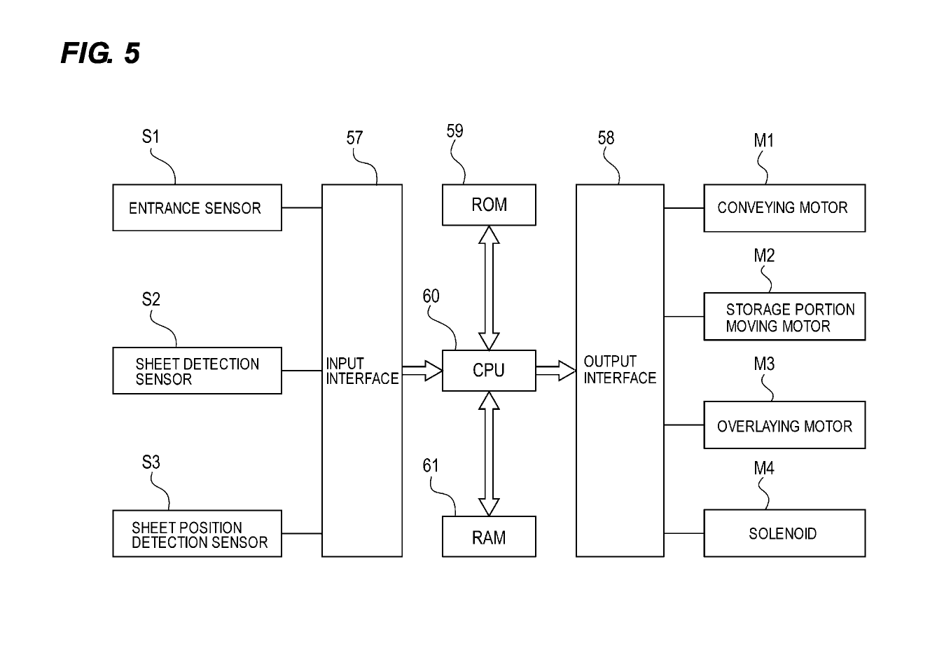

The sheet overlying portion 510 is provided with a reverse conveying roller 501 which can be rotated forward and reversely by an overlaying motor M3 illustrated in FIG. 5 which is referred to later. The sheet overlaying portion 510 is provided with a retraction path 503 which constitutes a retention portion for temporarily retaining preceding sheets. The retraction path 503 is branched from the sheet conveying path R upstream of the conveying roller 301 so that a sheet is conveyed thereto for temporary retention by reverse rotation of the conveying roller 301.

Here, the retraction path 503 is configured such that, when plural sheets are to be stored in the tray 330, the sheets from the first sheet to the sheet just before the final sheet are sequentially conveyed thereto by reverse rotation of the conveying roller 301. The retraction path 503 is provided with the reverse conveying roller 501 which can be rotated forward and reversely for conveying a sheet conveyed by reverse rotation of the conveying roller 301.

There is disposed, at the branching point where the retraction path 503 of the sheet conveying path R is branched, a switching member 502 for guiding a sheet to the retraction path 503 when the conveying roller 301 is reversely rotated. The sheet overlaying portion 510 is provided with a sheet position detection sensor S3 for detecting a position of sheet which is conveyed by reversely rotating the conveying roller 301.

The switching member 502 is rotated by a solenoid SL illustrated in FIG. 5 mentioned later which is operated based on a detection signal from the sheet position detection sensor S3. The switching member 502 is moved by the solenoid SL between a position illustrated with a solid line for guiding downstream a sheet conveyed from the pair of discharge rollers 110 and a position illustrated with a broken line for guiding a sheet conveyed by reverse rotation of the conveying roller 301 to the retraction path 503.

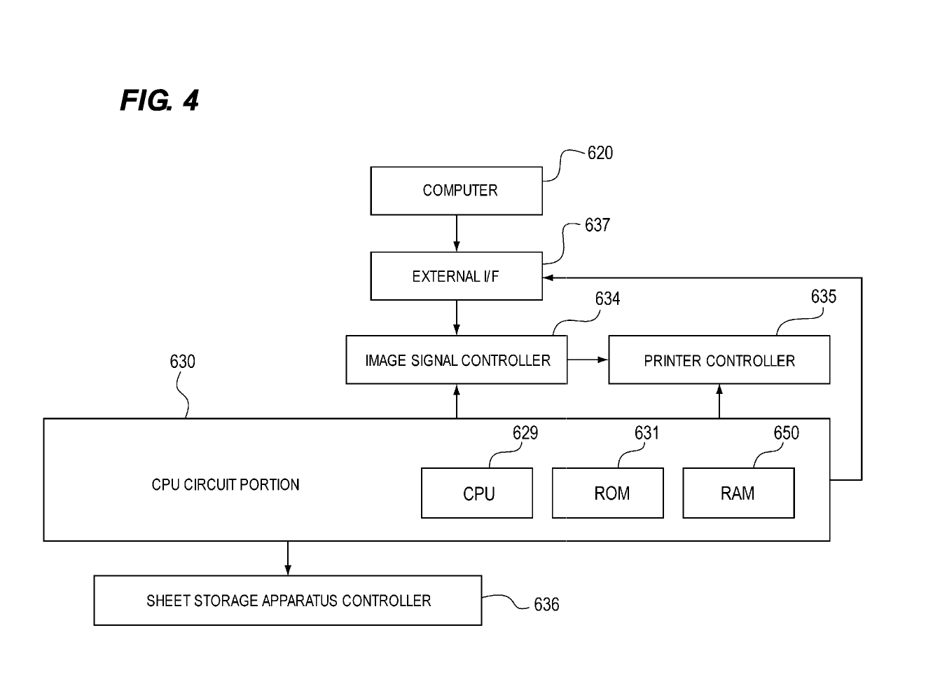

FIG. 4 is a control block diagram for controlling the image forming apparatus main body 100A and the sheet storage apparatus 300. As illustrated in FIG. 4, a CPU circuit portion 630 includes a CPU 629, a ROM 631, and a RAM 650. The CPU circuit portion 630 controls an image signal controller 634, a printer controller 635, a sheet storage apparatus controller 636, and an external interface 637 as an interface with an external PC (personal computer). The CPU circuit portion 630 controls the sheet storage apparatus controller 636 etc. according to a program stored in the ROM 631 and an input from an operation portion 601 disposed on the upper face of the sheet storage apparatus 300 as illustrated in FIG. 1. The operation portion 601 is provided for setting the whole of the image forming apparatus 100, and is disposed on the upper face of the image forming apparatus main body 100A when the sheet storage apparatus 300 is not mounted on the image forming apparatus main body 100A.

Here, the image signal controller 634 inputs image data which is input from an external PC 602 through an external interface 637 to the printer controller 635. The printer controller 635 controls the image forming apparatus main body 100A based on this image data. The sheet storage apparatus controller 636 is installed in the sheet storage apparatus 300 so as to control the sheet storage apparatus as a whole to be driven by exchanging information with the CPU circuit portion 630. In the present embodiment, the sheet storage apparatus controller 636 is installed in the sheet storage apparatus 300, but the present invention is not limited to this mode. The sheet storage apparatus controller 636 may be disposed in the image forming apparatus main body 100A integrally with the CPU circuit portion 630 so that the sheet storage apparatus 300 is controlled from the image forming apparatus main body side.

As illustrated in FIG. 5, the sheet storage apparatus controller 636 is constituted with a CPU 60, a RAM 61, and a ROM 59. The sheet storage apparatus controller 636 exchanges data by communicating with the CPU circuit portion 630 disposed on the image forming apparatus main body side via a communication interface (not shown). The sheet storage apparatus controller 636 executes various programs stored in the ROM 59 based on instructions from the CPU circuit portion 630 so as to control the sheet storage apparatus 300.

Here, when performing a sheet storage process control, the CPU 60 takes in various detection signals from various sensors for controlling the sheet storage apparatus 300 via an input interface 57. Note that, as such various sensors, the above-mentioned entrance sensor S1, the sheet detection sensor S2, and the sheet position detection sensor S3 are mentioned. The CPU 60 drives the above-mentioned conveying motor M1, the storage portion moving motor M2, the overlaying motor M3, and the solenoid SL, via an output interface 58.

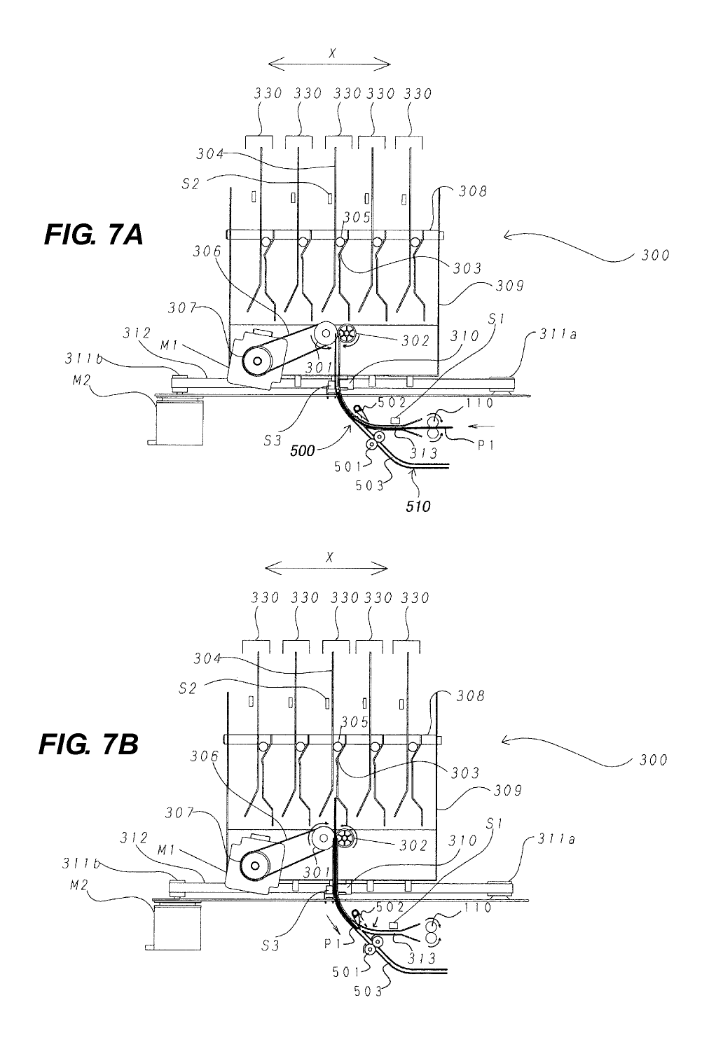

Next, a sheet storing operation control of the sheet storage apparatus 300 according to the present embodiment is described using the flow chart illustrated in FIG. 6. The sheet P1, on which an image has been formed, is discharged from the pair of discharge rollers 110 and delivered to the conveying guide 313. When the entrance sensor S1 is turned on by detecting this sheet (S10), the conveying motor M1 starts rotating forward (S11), thereby rotating forward the conveying roller 301 as illustrated in FIG. 7A.

Next, it is determined whether the number of output sheets of JOB, which has been input as information of sheet number from the operation portion 601 as an input portion which inputs the number of sheets to be stored in the tray 330, is plural (S12). When the number of output sheets is plural (YES of S12), the conveying motor M1 is stopped at the position where the sheet P1 has been conveyed by a predetermined amount after the sheet position detection sensor S3 turned on (S13), so as to stop the conveying roller 301. This stopping position is the position where the trailing edge of the sheet P1 has been conveyed downstream of the switching member 502.

Next, the solenoid SL is turned on (S14) so that the switching member 502 is located at the position illustrated with a broken line in FIG. 1 for guiding the sheet to the retraction path 503. After that, the conveying motor M1 and the overlying motor M3 are rotated reversely (S15) so that the conveying roller 301 and the reverse conveying roller 501 are rotated reversely. Accordingly, the sheet P1 is conveyed to the retraction path 503 as illustrated in FIG. 7B.

The sheet P1 thus conveyed to the retraction path 503 is delivered from the conveying roller 301 to the reverse conveying roller 501, after that, the conveying motor M1 and the overlaying motor M3 are stopped when the sheet P1 has been conveyed by a predetermined amount to the retraction path 503 (S16). This stopping position is a position where the trailing edge of the sheet P1 has been conveyed by a predetermined amount downstream of the conveying roller 301.

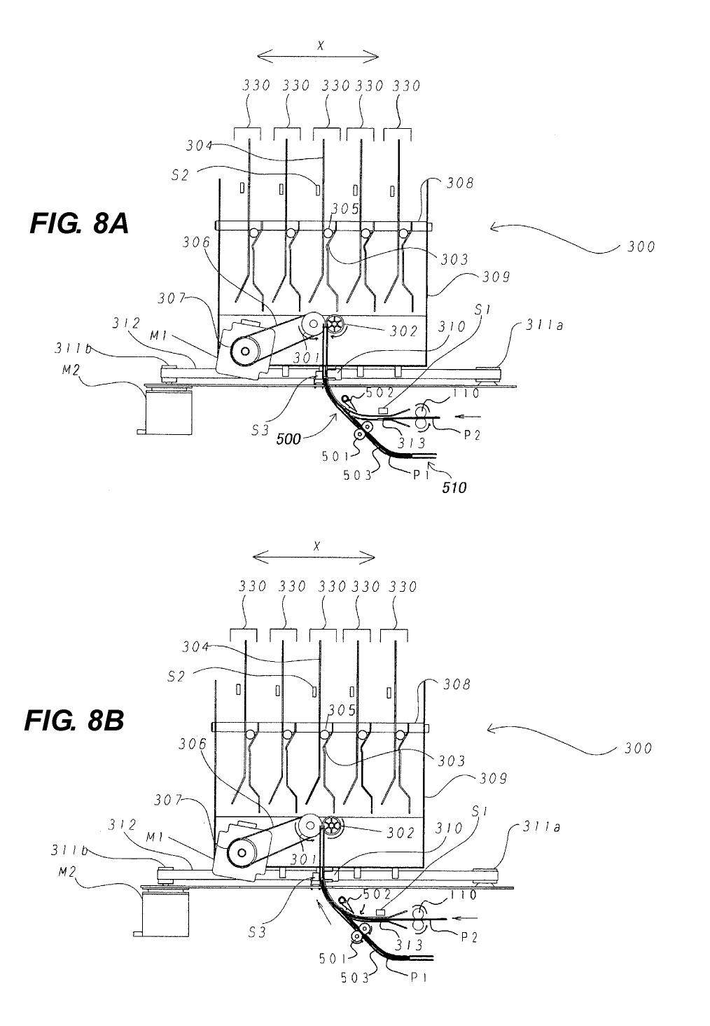

With this, a part of the first sheet P1 is conveyed into the retraction path 503. After that, the solenoid SL is turned off for receiving a sheet P2 which is conveyed next so that the switching member 502 is located at the position where the sheet P2 is guided downstream as illustrated in FIG. 8A. The next sheet P2 is delivered to the conveying guide 313 so that the sheet P2 is detected so as to turn on the entrance sensor S1 (S18), after that, the sheet P2 is conveyed by a predetermined amount.

After conveying the sheet P2 by a predetermined amount like this, the conveying motor M1 and the overlying motor M3 are rotated forward (S19). With this, the conveying roller 301 and the reverse conveying roller 501 are rotated forward so that the first sheet P1 conveyed to the retraction path 503 is conveyed as illustrated in FIG. 8B so as to bring the sheet P1 in a state of being overlaid on the next sheet P2. Note that, the timing when the conveying roller 301 and the reverse conveying roller 501 are rotated forward corresponds to the timing when respective leading edges of the overlaid sheets P1 and P2 are aligned with each other.

Next, after overlaying the two sheets P1 and P2 on one another like this, it is determined whether this sheet P2 is the final sheet (S20). Then, when this sheet P2 is not the final sheet (NO of S20), returning to S10, and the above-mentioned S11 to S20 are repeated. With this, the sheets from the first sheet to the sheet just before the final sheet are sequentially conveyed to the retraction path 503 in a state of being overlaid on one another.

After that, when the final sheet has been conveyed, the sheets retracted in the retraction path 503 are overlaid on this final sheet. When the designated number of sheets have been overlaid on one another, i.e., in the case that the overlaid sheet is the final sheet (YES of S20), the conveying motor M1 and the overlaying motor M3 are continued to rotate forward.

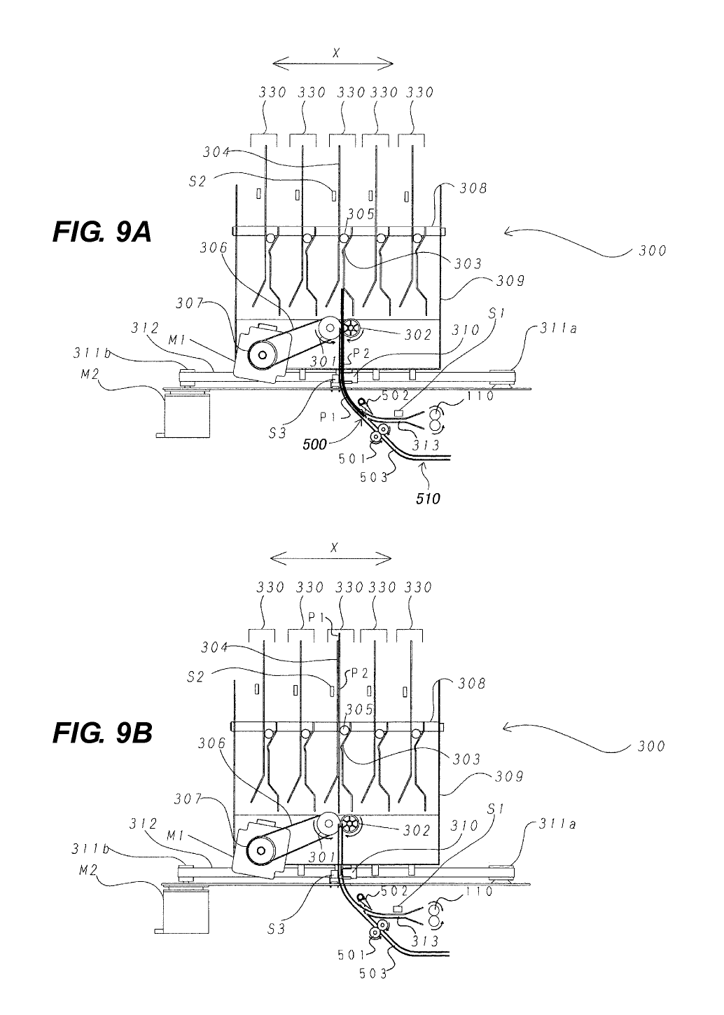

With this, as illustrated in FIG. 9A, the retracted sheets and the final sheet are integrally conveyed in a state of being overlaid on one another by the conveying roller 301 to the selected tray 330 (S21). After that, the sheets are held in the tray 330 as a sheet bundle in a substantially vertical state. When the number of output sheets is one (NO of S12), the conveying motor M1 is continuously rotated forward so as to convey the sheet to the tray 330 as illustrated in FIG. 9B (S21).

Here, even when the number of sheets of JOB designated to be output is plural, plural sheets are integrally conveyed to the tray 330 in a state of being overlaid on one another so that the plural sheets can be stored without disordering the storing state.

Note that, there may be a case that the number of sheets of JOB designated to be output exceeds the permissible maximum amount (permissible maximum number of sheets) which can be accommodated in the tray 330. In this case, first, when the number of overlaid sheets has reached the maximum amount, the overlaid sheets are integrally conveyed to the preliminary designated tray 330. Next, the trays 330 are moved in the right and left directions so that the tray 330, which has been found to store no sheet by the sheet detection sensor S2, is moved to the sheet storing position, and the remaining sheets are similarly overlaid on one another to be stored. With this, even when the number of sheets to be output exceeds the permissible maximum amount which can be stored in the tray 330, the sheets can be stored in the sheet storage apparatus 300.

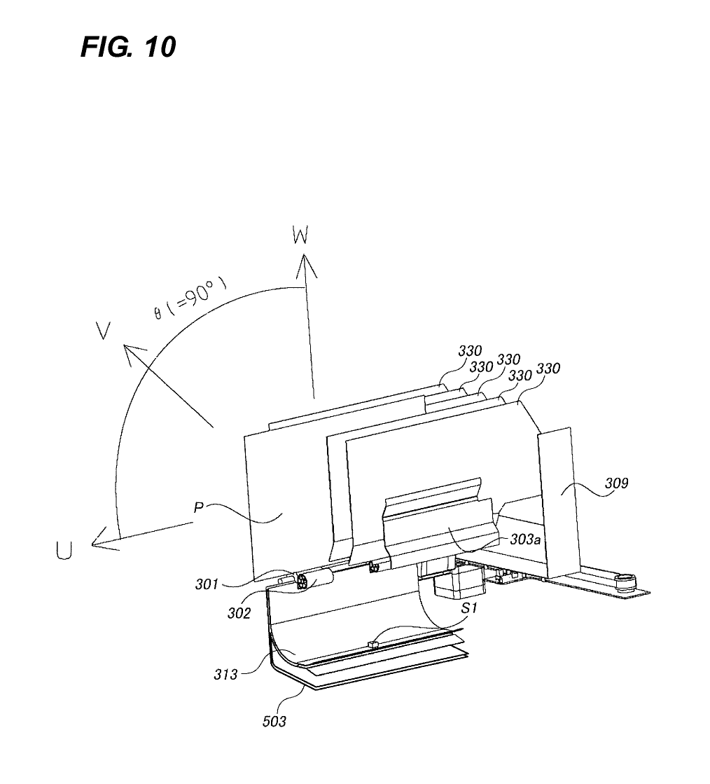

FIG. 10 is a perspective view illustrating the state where the sheet P is held in the tray 330. As illustrated in FIG. 10, the tray 330 is disposed at a back side position in the direction perpendicular to the sheet conveying direction of the conveying guide 313. With this, when the sheet is held by the tray 330, the front portion of the sheet P projects from the tray 330 toward the front side, i.e., the apparatus main body front side.

Accordingly, the sheet P stored in the tray 330 can be taken out in the range of the apparatus main body front side direction U denoted by angle θ (=90°) in FIG. 10, the apparatus main body front side obliquely upward direction V, and the upward direction W. When the sheet P is stored in the tray 330, the sheet P projects upward and frontward from the tray 330 so that the projected portions of the sheet P are conveniently grasped when the sheet P is taken out.

Then, when the bundle of the sheets P is taken out in the apparatus main body front side direction, the apparatus main body front side obliquely upward direction, and the upward direction denoted by arrow A in FIG. 3B, the wedge effect of the holding member 305 cannot be acted on the sheet P. Therefore, the sheet P, or a bundle of sheets P can be easily taken out from the tray 330 with one hand.

As described above, in the present embodiment, when plural sheets are to be stored in the tray 330, the sheets are sequentially conveyed by reverse rotation of the conveying roller 301 to the retraction path 503 until the final sheet has been conveyed from the apparatus main body 100A. When the final sheet has been conveyed, the sheets which have been sequentially conveyed to the retraction path 503 and the final sheet are integrally conveyed to the tray 330 in a state of being overlaid on one another. Accordingly, easiness of taking out sheets and a visual confirmation can be improved, and sheets can be stably stored.

Note that, in the foregoing descriptions, when the final sheet has been conveyed, the final sheet and the sheets conveyed to the sheet overlaying portion 510 are conveyed to the tray 330 in a state of being overlaid on one another, but the present invention is not limited to this mode. Namely, in the present invention, when plural sheets are to be stored in the tray 330, it is enough to convey plural sheets after being overlaid on one another by the sheet overlaying portion 510 to the tray 330 in this overlaid state. Therefore, for example, when the final sheet is conveyed, the final sheet is conveyed to the sheet overlaying portion 510, and this final sheet is conveyed to the tray 330 in a state where the final sheet is overlaid on the sheets which have already been conveyed to the sheet overlaying portion 510.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-105843, filed May 11, 2011, which is hereby incorporated by reference herein in its entirety.

What is claimed is:

1. A sheet storage apparatus comprising:
a sheet storage portion, having a sheet holding portion which allows a sheet to pass through in a sheet conveying direction and is able to restrict a movement of the sheet in a direction opposite to the sheet conveying direction, which receives the sheet conveyed from below and holds the sheet in a vertical state by the sheet holding portion so as to store the sheet; and
a sheet conveying portion, having an overlaying portion which overlays sheets to be stored in the sheet storage portion on one another, which conveys plural sheets in a state of being overlaid on one another by the overlaying portion to the sheet storage portion.

2. The sheet storage apparatus according to claim 1, wherein sheets are conveyed to the overlaying portion until a final sheet has been conveyed when the plural sheets are to be stored in the sheet storage portion, and the sheets conveyed to the overlaying portion and the final sheet are conveyed in a state of being overlaid on one another to the sheet storage portion when the final sheet has been conveyed.

3. The sheet storage apparatus according to claim 1, wherein the sheet conveying portion includes a conveying roller which is rotatable forward and reversely so as to convey the sheet, and the sheet is conveyed to the overlaying portion by rotating reversely the conveying roller.

4. The sheet storage apparatus according to claim 3, further comprising:
a controller which controls rotation of the conveying roller,
wherein the controller controls the rotation of the conveying roller so that, when the plural sheets are to be stored in the sheet storage portion, sheets are conveyed to the overlaying portion by rotating reversely the conveying roller until a final sheet has been conveyed, and so that, when the final sheet has been conveyed, the sheets conveyed to the overlaying portion and the final sheet are conveyed in a state of being overlaid on one another to the sheet storage portion without conveyance of final sheet to the overlaying portion by rotating reversely the conveying roller.

5. The sheet storage apparatus according to claim 3, further comprising a reverse conveying roller which is disposed at the overlaying portion so as to be rotatable forward and reversely, the reverse conveying roller taking in the sheet conveyed to the sheet overlaying portion by rotating reversely the conveying roller and conveying a taken-in sheet to the conveying roller by rotating forward the reverse conveying roller.

6. The sheet storage apparatus according to claim 3, further comprising:
a controller which controls rotation of the conveying roller,
wherein the controller controls the rotation of the conveying roller based on information on a number of sheets to be stored,
so that, when a single sheet is to be stored in the sheet storage portion, the conveying roller rotates forward so as to convey the sheet to the sheet storage portion, and
so that, when plural sheets are to be stored in the sheet storage portion, the conveying roller rotates forward and reverse such that the sheets conveyed to the overlaying portion and the final sheet are conveyed in a state of being overlaid on one another to the sheet storage portion.

7. The sheet storage apparatus comprising:
plural sheet storage portions which are disposed side by side along the lateral direction, each sheet storage portion has a sheet holding portion which allows a sheet to pass through in a sheet conveying direction and is able to restrict a movement of the sheet in a direction opposite to the sheet conveying direction, and is movable laterally so as to receive the sheet conveyed from below selectively and holds the sheet in a vertical state by the sheet holding portion so as to store the sheet; and
a sheet conveying portion, having an overlaying portion which overlays sheets to be stored in the sheet storage portion on one another, which conveys plural sheets in a state of being overlaid on one another by the overlaying portion to the sheet storage portion.

8. The sheet storage apparatus according to claim 7, further comprising:
a controller which controls movement of the plural sheet storage portions,
wherein, when the controller controls the movement of the plural sheet storage portions based on information on a number of sheets to be stored so that the number of sheets to be stored in the sheet storage portion exceeds a number of sheets which can be stored in a single sheet storage portion, the sheets are stored in the plural sheet storage portions.

9. An image forming apparatus comprising:
an image forming portion configured to form an image on a sheet;
a sheet storage portion, having a sheet holding portion which allows the sheet to pass through in a sheet conveying direction and is able to restrict a movement of the sheet in a direction opposite to the sheet conveying direction, which receives the sheet conveyed from below and holds the sheet in a vertical state by the sheet holding portion so as to store the image formed sheet; and
a sheet conveying portion, having an overlaying portion which overlays sheets to be stored in the sheet storage portion on one another, which conveys the plural sheets in a state of being overlaid on one another by the overlaying portion to the sheet storage portion.

10. The image forming apparatus according to claim 9, wherein sheets are conveyed to the overlaying portion until a final sheet has been conveyed from the image forming portion when the plural sheets are to be stored in the sheet storage portion, and the sheets conveyed to the overlaying portion and the final sheet are conveyed in a state of being overlaid on one another to the sheet storage portion when the final sheet has been conveyed.

11. The image forming apparatus according to claim 9, wherein the sheet conveying portion includes a conveying roller which is rotatable forward and reversely so as to convey the sheet, and the sheet conveyed from the image forming portion is conveyed to the overlaying portion by rotating reversely the conveying roller.

12. The image forming apparatus according to claim 11, further comprising:
a controller which controls rotation of the conveying roller,
wherein the controller controls the rotation of the conveying roller so that, when the plural sheets are to be stored in the sheet storage portion, sheets are conveyed to the overlaying portion by rotating reversely the conveying roller until a final sheet has been conveyed, and so that, when the final sheet has been conveyed, the sheets conveyed to the overlaying portion and the final sheet are conveyed in a state of being overlaid on one another to the sheet storage portion without conveyance of final sheet to the overlaying portion by rotating reversely the conveying roller.

13. The image forming apparatus according to claim 11, further comprising a reverse conveying roller which is disposed at the overlaying portion so as to be rotatable forward and reversely, the reverse conveying roller taking in the sheet conveyed to the overlaying portion by rotating reversely the conveying roller and conveying a taken-in sheet to the conveying roller by rotating forward the reverse conveying roller.

14. The image forming apparatus according to claim 11, further comprising:
a controller which controls rotation of the conveying roller,
wherein the controller controls the rotation of the conveying roller based on information on a number of sheets to be stored,
so that, when a single sheet is to be stored in the sheet storage portion, the conveying roller rotates forward so as to convey the sheet to the sheet storage portion, and
so that, when plural sheets are to be stored in the sheet storage portion, the conveying roller rotates forward and reverse such that the sheets conveyed to the overlaying portion and the final sheet are conveyed in a state of being overlaid on one another to the sheet storage portion.

15. The image forming apparatus comprising:
an image forming portion configured to form an image on a sheet;
plural sheet storage portions which are disposed side by side along the lateral direction, each sheet storage portion has a sheet holding portion which allows a sheet to pass through in a sheet conveying direction and is able to restrict a movement of the sheet in a direction opposite to the sheet conveying direction, and is movable laterally so as to receive the sheet conveyed from below selectively and holds the sheet in a vertical state by the sheet holding portion so as to store the image formed sheet; and
a sheet conveying portion, having an overlaying portion which overlays sheets to be stored in the sheet storage portion on one another, which conveys plural sheets in a state of being overlaid on one another by the overlaying portion to the sheet storage portion.

16. The image forming apparatus according to claim 15, further comprising:
a controller which controls movement of the plural sheet storage portions,
wherein, when the controller has determined, based on the information on the number of sheets to be stored from the input portion, that the number of sheets to be stored in the sheet storage portion exceeds a number of sheets which can be stored in a single sheet storage portion, the sheets are stored in the plural sheet storage portions.
